(19) United States
(12) Patent Application Publication
(10) Pub. No.: US 2013/0224693 A1
(43) Pub. Date: Aug. 29, 2013

(54) METHOD OF DETECTION OF USER CONFUSION HAVING FOLLOW-UP INSTRUCTIONS

(71) Applicants: Earnee Jones Gilling, Ypsilanti, MI (US); Rebecca L. Kirschweng, Dexter, MI (US)

(72) Inventors: Earnee Jones Gilling, Ypsilanti, MI (US); Rebecca L. Kirschweng, Dexter, MI (US)

(73) Assignee: Toyota Motor Engineering & Manufacturing North America, Inc., Erlanger, KY (US)

(21) Appl. No.: 13/408,746

(22) Filed: Feb. 29, 2012

(51) Int. Cl. G09B 9/04

(52) U.S. Cl. 434/62

(57) ABSTRACT

A method is disclosed for providing instructions to a user of a vehicle wherein the vehicle includes a plurality of sensors and a display screen. Instructions related to a vehicle operation are provided to the user by using the method comprising the steps of sensing by a sensor of a signal containing information regarding a condition indicative of confusion or human trigger of confusion, transmitting the signal containing the information regarding the confusion from the sensor to a processor, and then displaying instructions to the user on the display screen within the vehicle regarding how to remedy the confusion regarding the vehicle operation. The human trigger is sensed by a sensor or a plurality of sensors and includes detection of confusion when the vehicle user is pressing multiple buttons, incorrect buttons, pressing the same button multiple times, or a lack of pressing any buttons or triggers.

### FIELD OF THE INVENTION

This invention relates generally to information systems and, more particularly, to a system for use in a vehicle which detects user confusion and provides instructions to the user to correct said confusion.

### BACKGROUND OF THE INVENTION

It is well known in the art to use a vehicle operator's manual to look up instructions on how to properly perform a vehicle function. Although the standard procedure of looking up instructions in a vehicle operator's manual is helpful, the process is frequently overlooked because of the time consuming and inconvenient nature of the operation. To look up instructions in a vehicle operator's manual, the user must remove the manual from a glove box, check the index, and research where exactly the instructions for the vehicle operation are provided. Because of the time consuming process, numerous vehicle operations are overlooked by everyday users. These vehicle operations include setting memory set presets, setting radio station presets, turning the vehicle on, and other vehicle settings requiring any form of preset function.

Providing this information is vital to users of the vehicle to properly enjoy and operate the vehicle. Without the access to information, users of the vehicle are not afforded the full benefit of their new vehicle. Access to all information has recently become standard in many vehicles as shown by GPS navigation systems, radio systems, display apparatuses, and other similar information providing terminals. Although many common modem display apparatuses and information providing systems are known, providing information regarding vehicle operations through the modem display apparatuses is not known.

It is frequently known for vehicle users to attempt to set a preset on a vehicle seat and promptly give up the endeavor because they are not properly informed on how to properly set the preset on the vehicle seat. It is commonly known for a user to fumble with the buttons on the side of a vehicle seat or press the wrong buttons or the same button multiple times resulting in a failure of presetting the vehicle memory seat. Accordingly, there exists a need in the art to provide easily obtainable instructions to the user of the vehicle to start and follow through with a given vehicle operation, such as setting a vehicle memory seat.

### SUMMARY OF THE INVENTION

The present invention provides for a method for providing instructions to a user of a vehicle wherein the vehicle includes a plurality of sensors and a display screen. Instructions related to a vehicle operation are provided to the user by using the method comprising the steps of sensing by a sensor a human trigger of confusion, transmitting the signal containing the information regarding the confusion from the sensor to a processor, and then displaying instructions to the user on the display screen within the vehicle regarding how to remedy the confusion regarding the vehicle operation. The human trigger is sensed by a sensor or a plurality of sensors and includes detection of confusion when the vehicle user is pressing multiple buttons, incorrect buttons, pressing the same button multiple times, or a lack of pressing any buttons or triggers. For example, if a user is attempting to set the preset on a vehicle memory seat, and the user is struggling with how to properly set the preset by pressing the wrong button multiple times, this confusion is detected and a signal is transmitted to a processor which is then displayed on a display screen. Instructions are then provided on a display screen showing the user how to properly set the memory seat function on the vehicle seat.

### BRIEF DESCRIPTION OF THE DRAWINGS

FIG. 1 illustrates an environmental perspective view of a vehicle having an instruction providing system;

FIG. 2 illustrates a flowchart of the present system;

FIG. 3 illustrates a flowchart and display illustration for the system and method of linking a memory seat to a vehicle key;

FIG. 4 illustrates a flowchart and display illustration of providing instructions to a user regarding how to turn a vehicle on.

### DETAILED DESCRIPTION OF THE INVENTION

The present invention is a system to provide detailed instructions to a vehicle user upon detection of confusion by the user when the user is attempting to perform a vehicle operation. Sensors are used to determine and identify confusion of a user. That confusion signal is then sent to a processor which in turn displays a set of instructions to the user regarding how to properly achieve a vehicle operation. For example, if confusion is detected when a user is attempting to link or preset a vehicle key to a memory seat and detection of confusion is sensed, instructions regarding how to properly link the memory seat to a key are provided to the user for a predetermined length of time.

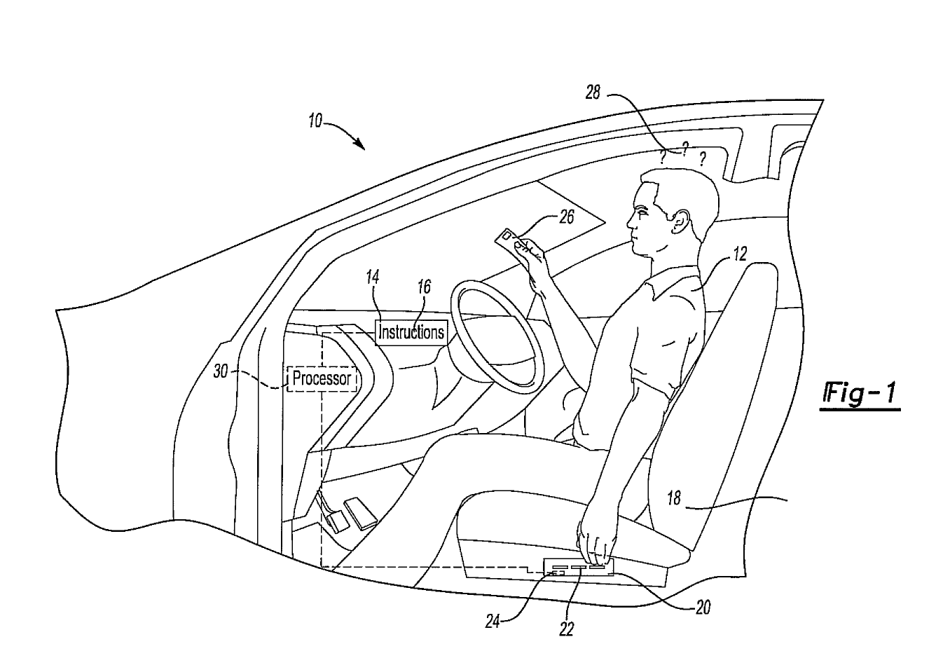

FIG. 1 illustrates a perspective view of a vehicle 10 having a user 12 seated therein. The vehicle 10 includes a display screen 14 providing instructions 16 to the user 12. As shown in this embodiment, the user 12 sits within a vehicle seat 18 having a button panel 20 and a plurality of buttons 22. The button panel 20 further includes a sensor 24 operable to detect confusion of the user 12 if the user is pressing the plurality of buttons 22 multiple times or pressing the wrong buttons 22. A vehicle key 26 is provided being used by the user 12. Once the confusion 28 is detected by the sensor 24 in the plurality of buttons 22, a signal is sent to the processor 30. The signal is then transmitted to the display screen 14 to display instructions 16 regarding how to link the memory seat to the vehicle key 26 for each independent user.

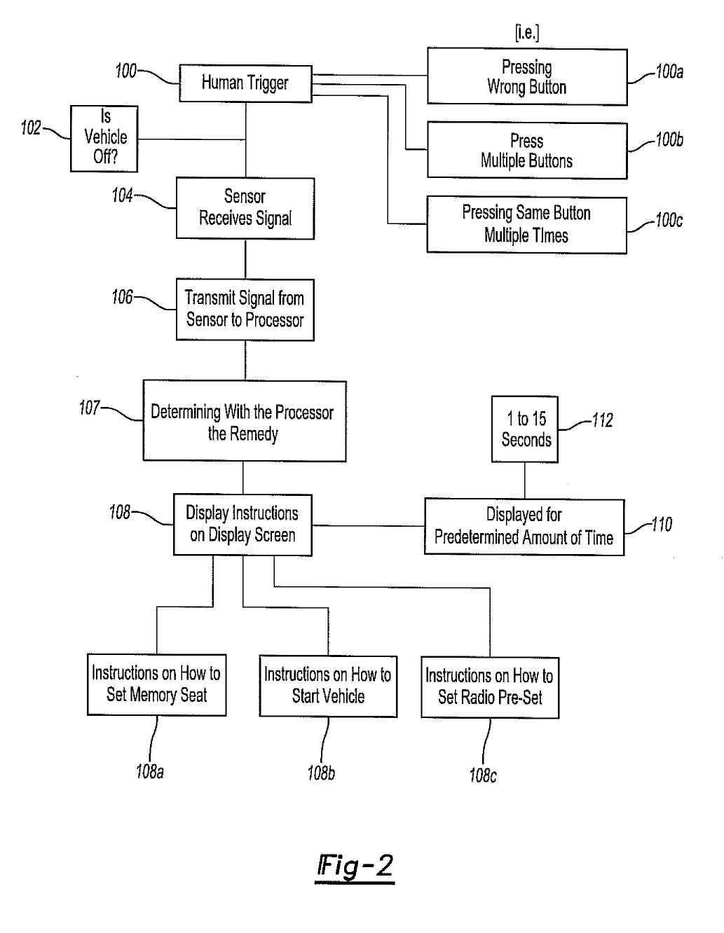

FIG. 2 illustrates the method for which a signal is transmitted from the sensor to the display screen. A condition indicative of confusion or human trigger 100 is required to initiate the system and method. The terms “condition indicative of confusion” and “human trigger” may be used interchangeably throughout this document. The human trigger may be, by way of example, pressing wrong buttons 100a, pressing multiple buttons 110b, or pressing the same button multiple times 100c. Either before or after the signal containing information regarding the confusion or human trigger 100 is sensed, the vehicle processor determines whether or not the vehicle is off 102 or in a parked position. The method and system, as a safety measure, will not initiate unless the vehicle is off 102 or the vehicle is in park 103 so as to reduce any user 12 distraction.

The sensor then receives the signal 104 from the sensor and the human trigger 100. The signal is then transmitted 106 from the sensor to a processor or computer on board the vehicle. The signal is transmitted either wirelessly, via Bluetooth, or via physically linked wire. Alternatively, the processor is an onboard computer, circuit board, or other system operable to transmit and process information received by the sensor. The processor then transmits information to a display screen and the display screen displays 108 instructions regarding the vehicle operation on a display screen. The instructions provided are displayed for a predetermined amount of time 110. This predetermined amount of time ranges between 1 and 15 seconds 112.

Display instructions on the display screen 108 may be displayed in a variety of fashions including, but not limited to, displaying in text form, illustration form, or otherwise. The instructions regarding the vehicle operation 108 may be instructions on how to set a memory seat 108a, instructions on how to start a vehicle 108b, or instructions on how to set a radio preset 108c.

Other instructions for various vehicle operations may also be provided such as how to open or close a window, how to open or close a moon roof, how to open or close a vehicle gas tank cover, how to open a trunk lid, how to fold down a vehicle seat, how to access storage within a vehicle, how to insert a CD within a vehicle radio, how to link an iPod or other media player to the vehicle, how to set cruise control, and other similar vehicle operations for which accessing a user manual is commonly required.

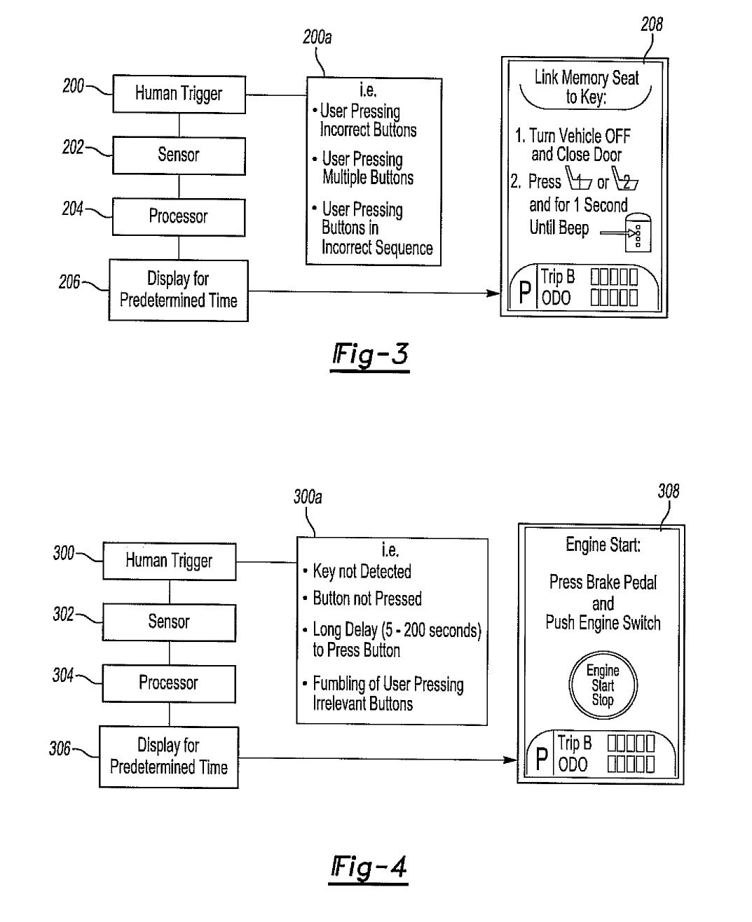

FIG. 3 illustrates the method and display for linking a memory seat to a key. A human trigger 200 is provided and required as a first step in the operation. This human trigger may be a user pressing incorrect buttons, a user pressing multiple buttons, or a user pressing buttons in an incorrect sequence 200a. A sensor 202 detects the human trigger within the system. The sensor transmits the information to a processor 204 which processes the information to be displayed on a display screen 206. The processor 204 determines the correct display to display on the screen. The processor is a computer operable to determine the appropriate instructions to display on the screen for the user to remedy the confusion. The information is displayed for a predetermined amount of time 206 on the vehicle screen 208.

The human trigger 200 is sensed by a sensor 202 or a plurality of sensors and includes detection of confusion when the vehicle user is pressing multiple buttons, incorrect buttons, pressing the same button multiple times, or a lack of pressing any buttons or triggers.

Numeral 208 illustrates one embodiment of the display of instructions to the user for linking a memory seat to a key. The steps include: (1) Turn the vehicle off and close door. (2) Press “1” or “2” and for 1 second until beep. The instructions further show a graphical representation of the vehicle key used by the user 12. These instructions easily allow the user 12 to link the memory seat to the vehicle key. The detailed instructions provided at reference numeral 208 are provided to easily allow a user to complete a vehicle operation. The detailed instructions are displayed after a processor determines the appropriate instructions to display.

FIG. 4 illustrates the method and display screen informing a user of how to properly start an engine. A human trigger 300 is required to start the method. The human trigger may be, by way of example, the key not detected in the vehicle, a button not pressed, a button not properly pressed, a long delay (5 to 200 seconds) to press a start button, or fumbling of user pressing irrelevant buttons 300a. A sensor 302 detects the human trigger and transmits a signal to the processor 304 regarding the user confusion. The processor 304 then transmits a signal to the display for a predetermined amount of time 306. The display 308 displays instructions on how to properly start the engine. These instructions include: “press brake pedal and push engine switch”. A graphical representation of the engine start-stop button is also illustrated within the instructions provided in the display screen at 308. These instructions provided in display screen 308 properly instruct the user 12 on how to start the vehicle engine after the processor determines that they are required to be displayed.

The invention is not restricted to the illustrative examples and embodiments described above. The embodiments are not intended as limitations on the scope of the invention. Methods, apparatus, compositions, and the like described herein are exemplary and not intended as limitations on the scope of the invention. The scope of the invention is defined by the scope of the appended claims. Changes therein and other uses will occur to those skilled in the art.

I claim:

1. A method for providing instructions to a user of a vehicle having a plurality of sensors instructions related to a vehicle operation, the method comprising the steps of:
sensing by a sensor a condition indicative of confusion by an operator with a sensor;
transmitting a signal containing information regarding the confusion from the sensor to a processor;
determining a remedy to the confusion with the processor; and
displaying instructions to the user regarding how to remedy the confusion regarding the vehicle operation.

2. The method of claim 1 further including the step of displaying the instruction for a predetermined length of time.

3. The method of claim 2 wherein the predetermined length of time ranged between 1 and 15 seconds.

4. The method of claim 1 wherein the sensing only occurs if the vehicle is off.

5. The method of claim 1 wherein the sensing only occurs if the vehicle is in park.

6. The method of claim 1 wherein the condition indicative of confusion is the user of the vehicle pressing multiple buttons.

7. The method of claim 1 wherein the condition indicative of confusion is the user of the vehicle pressing incorrect buttons.

8. The method of claim 1 wherein the condition indicative of confusion is pressing the same button multiple times.

9. The method of claim 1 wherein the condition indicative of confusion is a lack of pressing any button.

10. The method of claim 1 wherein the instructions to the user regarding how to remedy the confusion provide images of the correct button to press.

11. The method of claim 1 wherein the instruction to the user regarding how to remedy the confusion provide a detailed enumerated list of step by step instructions.
